(19) United States
(12) Patent Application Publication
(10) Pub. No.: US 2008/0052392 A1
(43) Pub. Date: Feb. 28, 2008

(54) System and Method for Monitoring a User's Online Activity

(76) Inventors: Jeff Webster, Phoenix, AZ (US); Narayanan Ramamrutham, Peoria, AZ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/749,713

(22) Filed: May 16, 2007

Related U.S. Application Data
(60) Provisional application No. 60/801,490, filed on May 18, 2006.

(51) Int. Cl. G06F 15/173

(52) U.S. Cl. 709/224

(57) ABSTRACT

A system and method for monitoring online activity by a user or other online agent, for example, in web browsing, viewing of video or music content, or other online activities. In one aspect, the method comprises receiving program code (e.g., a script) on a client (e.g., running a web browser) from a first server (e.g., a web server) in a first domain. The program code is executed at the client to read a file (e.g., a cookie) to obtain activity information corresponding to online activity by the client (e.g., web browsing). The activity information is sent (e.g., using a phantom object request made by the program code) to a tracking server in a different domain.

### RELATED APPLICATION

This application is a non-provisional application claiming benefit under 35 U.S.C. sec. 119(e) of prior U.S. Provisional Application Ser. No. 60/801,490, filed May 18, 2006 (titled SYSTEM AND METHOD FOR MONITORING A USER'S ONLINE ACTIVITY by Webster et al.), which is incorporated by reference herein.

### BACKGROUND

1. Field

The present disclosure relates in general to the monitoring of online activity, and more particularly to a system and method for monitoring online activity by a user, for example, in web browsing, viewing of video or music content, or other online activities.

2. General Background

A cookie is typically a small file of text sent by a web server to a World Wide Web (WWW) browser. The cookie is later sent back to the server by the browser (e.g., when the browser again accesses the server). HTTP cookies may be used for user authentication, user tracking, and maintaining user-specific information such as site preferences and electronic shopping carts.

Cookies can be used for tracking the browsing of a user. However, cookies are typically simple pieces of data not able to perform an operation by themselves. For example, they are not spyware or viruses. Most modern browsers allow users to decide whether to accept cookies, but rejection makes some web sites unusable. For example, shopping baskets implemented using cookies will not work if a browser is set to reject cookies.

Cookies are used by web servers to differentiate users and to operate in a way that depends on the user. Third-party cookies are often used to track users across multiple sites. Tracking across sites is typically used by advertising companies to produce user profiles for targeted advertising based on a user's profile.

Cookies may be various types of information or data selected by the web server and sent to the browser. The browser typically returns them unchanged to the server, introducing a state (memory of prior activity) into an otherwise stateless transaction. Without cookies, each retrieval of a web page would be an isolated event. By returning a cookie to a web server, the browser provides the server a means of connecting the current page being viewed by the user with prior page views.

The cookie can be set to specify a date of expiration, in which case the cookie will be deleted on that date. If a date is not specified, the cookie is deleted once the user exits the current browser session. A cookie that is set without expiration is referred to as a session cookie. A cookie with an expiration date is stored on the file system in a location specific to the browser being used; this type of cookie is referred to as a persistent cookie.

Cookies may be used to monitor a user's web activity. A cookie is only sent to the server that initially set it or another server in the same Internet domain. However, a web page may contain images or other components stored on servers in other domains (i.e., in a different top-level domain). Cookies that are set during retrieval of these components are called third-party cookies.

As mentioned above, advertising or other companies may use third-party cookies to track a user across multiple sites. In particular, an advertising company can track a user across all pages where it has placed advertising images. Knowledge of the pages visited by a user allows the advertising company to target advertisements to the user's profile. If a browser has been set to disable third party cookies, the advertising company is not able to readily track a user's viewing of advertisements.

Thus, there is a need for an improved system and method for monitoring online activity by a user, for example, in web browsing or other online activities.

### BRIEF DESCRIPTION OF THE DRAWING

For a more complete understanding of the present disclosure, reference is now made to the following figure:

FIG. 1 is a functional block diagram illustrating a system for monitoring online activity in accordance with one embodiment.

The exemplification set out herein illustrates particular embodiments, and such exemplification is not intended to be construed as limiting in any manner.

### DETAILED DESCRIPTION OF THE DISCLOSURE

The following description and the drawing illustrate specific embodiments sufficiently to enable those skilled in the art to practice the system and method described. Other embodiments may incorporate structural, logical, process and other changes. Examples merely typify possible variations. Individual components and functions are optional unless explicitly required, and the sequence of operations may vary. Portions and features of some embodiments may be included in or substituted for those of others.

The elements that implement the various embodiments of the present system and method are described below, in some cases at an architectural level. Many elements may be configured using well-known structures.

The processing described below may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any type of memory as is conventional in the art. By way of example, such data may be stored in a temporary memory, such as in the random access memory (RAM) of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including existing memory technologies as well as hardware or circuit representations of such structures and of such data.

It should also be understood that the techniques of the present system and method might be implemented using a variety of technologies. For example, the methods described herein may be implemented in software running on a programmable microprocessor, or implemented in hardware utilizing either a combination of microprocessors or other specially designed application specific integrated circuits, programmable logic devices, or various combinations thereof. In particular, the methods described herein may be implemented by a series of computer-executable instructions residing on a storage medium such as a disk drive or other computer-readable medium.

As used herein, the term “entity” refers to an individual, corporation, partnership, or other type of legal entity.

As used herein, the term “NSO” means natural search optimization.

The transmission of web pages typically uses HyperText Transfer Protocol (HTTP). A browser may request a page from a web server by sending an HTTP request. The server may reply by sending the requested page preceded by an HTTP header. This header may contain code requesting the browser to store cookies. For example, the code may request the browser to store the string name=value and send it back in all future requests to the server. If the browser supports cookies, every subsequent page request to the same server will typically contain the cookie. Cookies may also be set, for example, by javascript or similar scripts running within the browser.

A typical cookie may contain a name/value pair, an expiration date, a path, and a domain name. RFC 2109, which is hereby incorporated by reference herein, provides additional information regarding cookies. The domain and path indicate the server to which the browser will send the cookie when URLs of a given domain and path are requested. If not specified, they typically default to the domain and path of the object that was requested. The cookie is accepted only if the server is a member of the domain specified by the domain string.

Cookies may be used for tracking the path of a user while visiting a web site. For example, if the user requests a page of the site, but the request contains no cookie, the server assumes that this is the first page visited by the user. The server may create a random identifier and send it as a cookie back to the browser together with the requested page. Now, the cookie may be sent to the server every time a new page from the site is requested. The URL and time/date stored with the cookie allows finding out which pages the user has visited, and at which time.

Images or other objects contained in a web page may reside in servers other than the one hosting the page. In order to show such a page, the browser may download these objects and may receive cookies. These cookies are known as third-party cookies if the server sending them is located outside the domain of server that hosts the web page.

This often is seen with on-line advertisements. For example, web banners are typically stored in one or more servers of an advertising company, which are not in the domain of the server hosting the web page. If third-party cookies have not been disabled on the browser, an advertising company may track a user across the sites where it has served a banner. If this server has previously set a cookie, the browser may send it back, allowing the advertising company to link this access with prior ones. By chosing a unique banner URL for every web page where it is placed, the advertising company may determine which pages the user has previously viewed. This approach may also be used with so-called “web bugs”, which are still images embedded in a web page, but invisible to the user.

Cookie specifications typically constrain cookies to be sent back only to the servers in the same domain as the server from which they originate. However, the value of cookies may be sent to other servers using means other than the cookie's header. For example, scripting languages such as javascript are typically allowed access to cookie values and permit the sending of values to arbitrary servers on the Internet. This approach is not readily detected on the user side because the script is coming from the same domain that set the cookie (i.e., the sending of the value appears to be authorized by this domain).

As mentioned previously, if a browser has been set to disable third party cookies, then an advertising company is not able to track a user's viewing of advertisements. In particular, the most popular Internet browsers typically have a default setting to reject third-party cookies. Unsophisticated users, which may be the primary advertising target market, are less likely to know how or be motivated to change this default setting. Thus, advertising performance of an advertising campaign cannot be fully monitored for such users. Similarly, the monitoring (e.g., by web-based businesses) using third party cookies for the licensing or other providing of online goods, services or activities (e.g., viewing and licensing of video or music content) will not be fully effective.

A system and method for monitoring online activity by a user or other online agent, for example, in web browsing, viewing of video or music content, or other online activities are now described below. In one aspect, a method for monitoring online activity comprises receiving program code (e.g., a script) on a client (e.g., running a web browser) from a first server (e.g., a web server) in a first domain (e.g., business.com). The program code is executed at the client to read a file (e.g., a cookie) to obtain activity information corresponding to online activity by the client (e.g., a user's web browsing). The activity information is sent to a second server in a second domain not the same as the first domain (e.g., collectdata.com).

As an alternative to providing the program code directly from the first server, another server location (in or outside of the first domain) may be identified by and provided from the first server (e.g., by providing a URL as a location identifier). The program code is then loaded by the client from the other server location. This server location may be, for example, the second server or a server or other device (e.g., cellular phone with wireless Internet capability) located within the second domain.

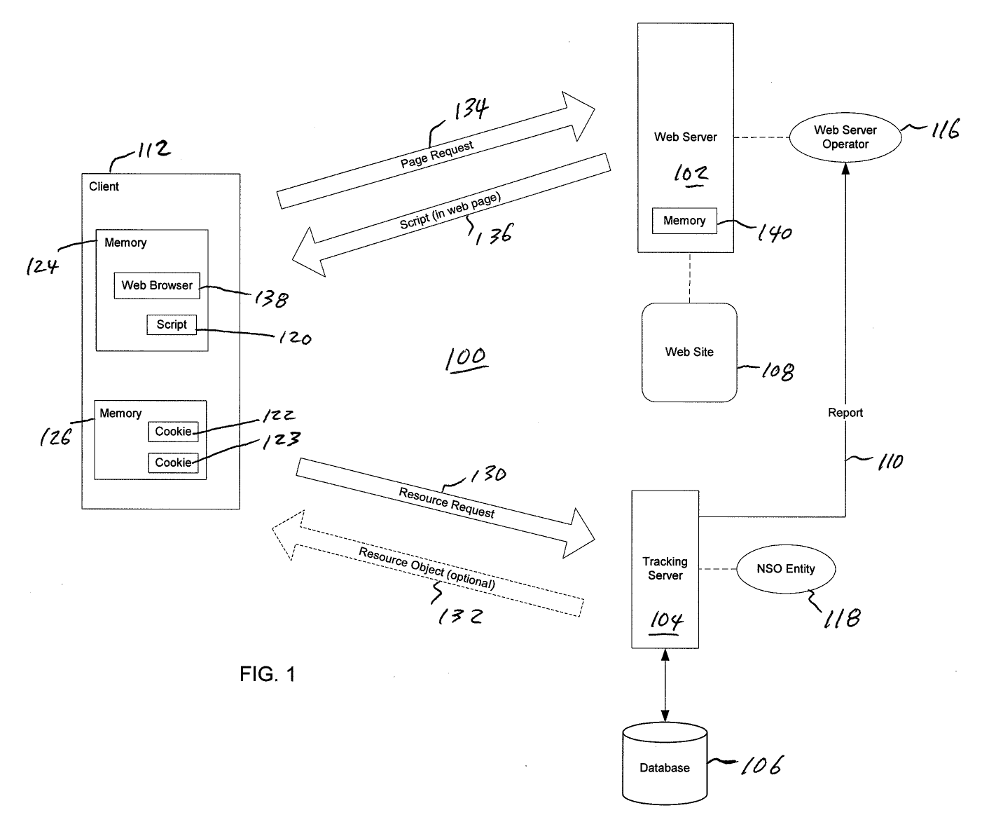

FIG. 1 is a functional block diagram illustrating a system for monitoring online activity. Specifically, a monitoring system 100 comprises a web server 102 in communication with a client 112 (e.g., over an Internet or wide area network connection). Web server 102 serves web pages and web sites (e.g., web site 108) in response to requests made from client 112 (e.g., via page request 134). Web server 102 may comprise memory 140 (e.g., RAM and/or a hard drive) for storing computer program instructions.

A web page on web site 108 may be served by web server 102 in response to a request from client 112. Client 112 may be, for example, an Internet or web browser 138 executed by a user, for example, on a personal computer or a cellular phone. Client 112 may in some cases be a search engine (e.g., spider or webcrawler). An example of a web page is a page that advertises products and prices in an online store catalog.

Program code 136 (e.g., javascript or other script) may be provided, for example, embedded in one or more web pages or other files provided by server 102. Program code 136 may be used to set and read local files on client 112, and to initiate the sending of user identification or activity information to tracking server 104. Program code 136 may alternatively be sent separately from a web page served by web server 102.

It is not required, in contrast to other approaches, that an image (e.g., via an HTML <IMG> tag) be embedded in a web page provided from web server 102 for the monitoring of online activity as described herein. However, it may be desirable in some cases to embed an image in the web page in conjunction with the embedding of program code 136 in the web page.

In one embodiment, program code 136 is a script file 120 that is stored in memory 124 on client 112. Memory 124 may be, for example RAM or another type of memory suitable for storing program instructions for execution by client 112. Web browser 138 may also be stored in memory 124. Script 120 may be, for example, run within web browser 138. Also, script 120 may be, for example, a background script.

Script 120 may set and read cookies 122 and 123, which may be stored in permanent memory 126 (e.g., a hard drive or other memory storage device). Cookies 122,123 may be, for example, permanent or session cookies. When initiating resource request 130, script 120 (or any other type of program code 136 earlier received by client 112) may read information from cookies 122 and/or 123. Cookies 122 or 123 may also be stored, for example, on another device on the same local area network as client 112.

During the operation of web browser 138, information regarding online activity by client 112 may be stored in cookies 122 and/or 123 (or alternatively in another type of file stored on client 112). Cookies 122 and/or 123 may also store unique identifiers associated with client 112, the user thereof, and/or particular settings or options associated with the user's visit to web site 108.

A tracking server 104 may be used to collect data regarding online activity by client 112. Tracking server 104 is typically in a top-level domain that is not the same as the top-level domain in which web server 102 is located. In some cases, tracking server 104 may also be an advertisement server.

In one example, tracking server 104 may be owned or operated by NSO entity 118. Web server 102 may be owned or operated by web server operator 116 (e.g., a customer of NSO entity 118). In some cases, NSO entity 118 may be engaged by web server operator 116 to perform monitoring of advertising campaigns and/or NSO consulting for the website 108.

A database 106 may run on tracking server 104. Database 106 may collect tracking and other activity information sent to tracking sever 104 by, for example, client 112. In alternative embodiments, database 106 may run on another server (e.g., in the same domain as tracking server 104).

Client 112 may make a resource request 130 to tracking server 104. Resource request 130 may be initiated or controlled by the program code 136 earlier provided to client 112. Communication between client 112 and tracking server 104 may be implemented, for example, using a conventional Internet or other communications interface.

Resource request 130 identifies, for example, a resource object referenced by script 120 during execution by web browser 138. Resource object 132, although requested by resource request 130, is typically not provided to client 112. Tracking of activity by tracking server 104 does not depend upon the actual receipt of the resource object 132 by client 112. However, in other embodiments, resource object 132 may be provided to and used by client 112.

As an example, resource request 130 (e.g., an HTTP request) may request a background image object specified in script 120. For the image object to be triggered, parameters associated with the object may be passed to tracking server 104 as part of resource request 130. The parameters contain activity information that has been read from cookies 122,123. Tracking server 104 collects and stores this information.

NSO entity 118 may, for example, own or operate tracking server 104. Information received from client 112 may be used to generate and provide tracking or other activity reports 110 to web server operator 116, which may, for example, receive such reports electronically (e.g., over the Internet) or in tangible form (e.g., hard-copy mailing).

In other embodiments, additional program code may be loaded onto client 112 by the execution of the initial program code 136 on client 112. For example, during execution, script 120 may load other script files onto client 112. Also, a web page read by web browser 138 may reference script files on web server 102, tracking server 104, or another server (not shown).

The web page received by client 112 may be, for example, a secure page. In this case, resource request 130 may be communicated over a secure channel (e.g., a secure socket connection).

Phantom Image Object Request

Some tracking methods use an image tag (e.g., HTML) to place an “invisible” image in a web page loaded by a web browser. For example, the following code may be used:
<img src=“http://www.ic-live.com/puppy.php?arguments”>

When a browser comes across the above code, it connects to a tracking server and requests, for example, “puppy.php”, which returns an image of size 1-pixel by 1-pixel to the browser after processing the “arguments” that were passed in. The “puppy.php” script also attempts to read and/or set cookies on the client (i.e., third-party cookies). These arguments typically include user/visitor specific information. Other information about the visitor may also be included (e.g., type of browser).

Other tracking methods use an image tag (e.g., HTML) that is written to the page via javascript. The end result is the same as described for the method above. The actual <img> tag is written to the page using, for example, the JavaScripts document.writeo method. As an example, the following code may be used:

<script type=”text/javascript”>
var clientid = 1024;
var domainid = 1136;
var url = “http://www.ic-
live.com/puppy.php?clientid=”+clientid+”&domainid=
”+domainid+”&arguments”;
document.write(“<img src=’”+url+”’>”);
</script>

The method above writes essentially the same information to the page as appears in the first tracking method above.

The new monitoring method for monitoring of online activity described herein may use, for example, pure javascript. This method does not need to include the writing of an HTML image, though the new method could be combined with one or both of the above tracking methods if desired. The two tracking methods above rely on an <img> HTML tag generating a hit on a tracking server in another domain (i.e., a third party domain).

Script 120 (e.g., implemented in javascript) may be used to set cookies 122 and/or 123. Because the javascript is hosted on the same domain as client 112, the cookies are, by default, first party cookies. The javascript can both read and set the cookies, and also immediately determine if cookies are enabled.

A phantom image object may be created in the javascript, having its “src” property (which identifies the resource location of the actual image data) set to tracking server 104 (or a cluster of tracking servers in the same domain). The phantom object is referred to as being “phantom” because it never actually exists in the page loaded on client 112 (i.e., a phantom object is an undisplayed object). Typically, no attempt is made to display the phantom object to the user. Rather, it may be discarded upon the page being completely loaded. By that time, the request 130 has already been made to tracking server 104 so that the visit can be tracked. The logic in the “puppy.php” code above has essentially been placed in the javascript code. For example, the following code may be used:

<script type=”text/javascript”>
var clientid = 1024;
var domainid = 1136;
// The puppy.php functionality has been moved into setCookies( ) and
getCookieData( )
setCookies( );
var arguments = getCookieData( );
var url = “http://www.ic-
live.com/puppy.php?clientid=”+clientid+”&domainid=”+domainid+
”&arguments”;
var icPixel = new Image( ); // create phantom Image object.
icPixel.src = url;
// done.
</script>

System Implementation

The system and method for monitoring online activity described above generally may be implemented using conventional hardware and network communication components and software programming techniques and languages. In appropriate cases, reports from and interaction with monitoring system 100 may be provided as a web or local service to web server operator 116 by NSO entity 118. Monitoring system 100 may, for example, be developed using a distributed, component-based architecture that can be scaled to accommodate a large number of sessions per day.

The software used to operate monitoring system 100 may be executed on client 112 and one or more servers. Client 112 may be, for example, a personal computer or PDA. The networks used for communications by monitoring system 100 may be, for example, a combination of the following: the Internet, a mobile phone network, or a local or wide area network. Client 112 and servers 102, 104 of monitoring system 100 may execute various modules of software to implement one or more of the functions described above. Some of these software modules may, for example, be distributed across multiple servers.

Conclusion

By the foregoing description, an improved system and method for monitoring online activity have been described. The improved system and method may be substantially web-based.

The foregoing description of specific embodiments reveals the general nature of the disclosure sufficiently that others can, by applying current knowledge, readily modify and/or adapt it for various applications without departing from the generic concept. For example, the above system and method are not specific to HTTP browsing agents, but may be generally applied to other client-server implementations where the client is capable of executing background scripts that are embedded in files being served from the server to the client.

As a specific example, in digital video presentations scripts may be executed to track licensing. The method described above also may be used to embed other scripts for the purposes of tracking content delivery and visitor viewing habits. In the case of other media types, such as digital music delivery, the same tracking methods may be applied.

Also, in other embodiments client 112 may receive a second script from web server 102 that is used to track content delivery requested from the client or to track visitor viewing habits by a user of client 112. In yet other embodiments, cookie 122 or 123 may be set by another device in the same domain as web server 102.

Therefore, such adaptations and modifications are within the meaning and range of equivalents of the disclosed embodiments. The phraseology or terminology employed herein is for the purpose of description and not of limitation.

1. A method for monitoring online activity comprising:
receiving program code or a location identifier for the program code on a client from a first server in a first domain;
executing the program code at the client to read a file to obtain activity information corresponding to online activity by the client; and
sending the activity information to a second server in a second domain not the same as the first domain.

2. The method of claim 1 wherein the location identifier is a uniform resource locator.

3. The method of claim 1 wherein the location identifier references a device in the second domain.

4. The method of claim 3 wherein the device is the second server.

5. The method of claim 3 further comprising receiving the program code at the client from the device in the second domain.

6. The method of claim 1 wherein the program code is a script, the first server is a web server, the client is a web browser, the file is a cookie, and the online activity is prior or current activity by the web browser.

7. (canceled)

8. The method of claim 6 wherein the script is embedded in the program code.

9. The method of claim 1 wherein the file is accessible by the client from a memory storage device on the client or on a local area network.

10. The method of claim 1 further comprising processing the activity information at the second server to track online activity by a user on the client.

11. (canceled)

12. The method of claim 1 further comprising:
sending a request from the client for a resource object specified by the script as being located on the second server; and
passing at least a portion of the activity information to the second server as part of the request.

13. The method of claim 12 wherein the request is an HTTP request and the resource object is an image object.

14. The method of claim 12 wherein the resource object is a background image object.

15. The method of claim 1 further comprising tracking visitors to a web site hosted by the first server.

16. (canceled)

17. The method of claim 1 wherein the program code is a first script, and further comprising receiving a second script on the client that is used to track content delivery requested by the client or to track visitor viewing habits by a user on the client.

18. A system comprising at least one memory storing computer-executable instructions for:
receiving program code or a location identifier for the program code on a client from a first server in a first domain;
executing the program code at the client to read a file to obtain activity information corresponding to online activity by the client; and
sending the activity information to a second server in a second domain not the same as the first domain.

19. The system of claim 18 wherein the at least one memory comprises a first memory on the client and a second memory on the second server.

20. (canceled)

21. A computer-readable medium having computer-executable instructions for:
receiving program code or a location identifier for the program code on a client from a first server in a first domain;
executing the program code at the client to read a file to obtain activity information corresponding to online activity by the client; and
sending the activity information to a second server in a second domain not the same as the first domain.

22. A method for tracking web usage by a user comprising:
receiving a script at a web browser, executing on a client, from a web server in a first domain;
executing the script at the client to read a cookie, stored on or accessible by the client, to obtain activity information corresponding to browsing activity using the web browser; and
sending the activity information to a tracking server in a second domain not the same as the first domain.

23. The method of claim 22 wherein receiving the script comprises receiving the script as embedded in a web page requested by the web browser from the web server.

24. The method of claim 22 further comprising setting the cookie by the first server or another device in the first domain.

25. The method of claim 22 wherein the script is a background script.

26. A method for tracking web usage by a user comprising:
requesting a web page using a web browser, executing on a client, from a web server;
receiving a script at the client provided in or identified by the web page;
executing the script at the client to read a cookie, stored on or accessible by the client, to obtain information corresponding to browsing activity; and
sending the information to a tracking server in a second domain not the same as the first domain.

27. The method of claim 26 wherein the script comprises code for a phantom object that identifies the phantom object location to be in the second domain.

28. The method of claim 27 wherein the phantom object is discarded upon the complete loading of the web page by the web browser.

29. The method of claim 27 wherein the information sent to the tracking server is part of a request made by the script to the tracking server to create the phantom object.
